(19) United States
(12) Patent Application Publication
(10) Pub. No.: US 2014/0176288 A1
(43) Pub. Date: Jun. 26, 2014

(54) ELECTROMAGNETIC INDUCTION MODULE FOR WIRELESS CHARGING ELEMENT AND METHOD OF MANUFACTURING THE SAME

(71) Applicant: SAMSUNG ELECTRO-MECHANICS CO., LTD., Suwon (KR)

(72) Inventors: Chang Ryul JUNG, Suwon (KR); Dong Hyeok Choi, Suwon (KR); Sung Yong An, Suwon (KR)

(73) Assignee: SAMSUNG ELECTRO-MECHANICS CO., LTD., Suwon (KR)

(21) Appl. No.: 13/772,528

(22) Filed: Feb. 21, 2013

(30) Foreign Application Priority Data
Dec. 21, 2012 (KR) 10-2012-0151009

(51) Int. Cl. H01F 27/255; H01F 41/04; H01F 27/28

(52) U.S. Cl. CPC H01F 27/255; H01F 27/2804; H01F 41/04
USPC 336/207; 29/607

(57) ABSTRACT

There is provided an electromagnetic induction module for a wireless charging element, the electromagnetic induction module including a magnetic sheet including magnetic particles and having a groove portion formed in one surface thereof, the groove portion having a shape corresponding to a coil pattern, and a coil disposed in the groove portion.

### CROSS-REFERENCE TO RELATED APPLICATIONS

This application claims the priority of Korean Patent Application No. 10-2012-0151009 filed on Dec. 21, 2012, in the Korean Intellectual Property Office, the disclosure of which is incorporated herein by reference.

### BACKGROUND OF THE INVENTION

1. Field of the Invention

The present invention relates to an electromagnetic induction module for a wireless charging element allowing for a reduction in a thickness of a wireless charging element and improving charging efficiency, and a method of manufacturing the same.

2. Description of the Related Art

In general, an electromagnetic induction-type wireless charging principle includes a system in which a magnetic field induced in a wireless charging module by an AC current generates induced electromotive force in coils inserted into communication devices such as smartphones and secondary batteries is charged with the generated induced electromotive force.

Wireless charging efficiency is determined based on variations in magnetic flux changed on an hourly basis, according to Faraday's Law.

In general mobile devices, a space in which a wireless charging module is mounted may be in the vicinity of a battery, such that efficiency of a wireless charging system may be reduced due to a battery.

In order to solve the above limitation, a magnetic sheet is used to prevent the efficiency of the wireless charging system from being reduced due to a battery.

According to a wireless charging method according to the related art, charging is undertaken using an electromagnetic induction method in a system including a transmitter and a receiver, and in this case, the receiver includes a coil and a magnetic sheet separated from each other, and the coil and the magnetic sheet are bonded to each other by an adhesive layer.

However, a wireless charging element may be relatively thick and space efficiency thereof may be degraded, due to the adhesive layer.

As a result, in order to reduce the thickness of a wireless charging element and increase charging efficiency thereof, demand for an improvement in the magnetic sheet has been steadily increasing.

Patent Document 1, the following related art document, discloses a wireless charging sheet including a magnetic sheet, an adhesive layer, and a coil, but does not disclose a structure in which a groove portion is formed in a sheet, as in the case of the present invention.

### Related Art Document

(Patent Document 1) Korean Patent Laid-Open Publication No. 10-2009-0113418

### SUMMARY OF THE INVENTION

An aspect of the present invention provides an electromagnetic induction module for a wireless charging element allowing for a reduction in a thickness of a wireless charging element and improving charging efficiency, and a method of manufacturing the same.

According to an aspect of the present invention, there is provided an electromagnetic induction module for a wireless charging element, including: a magnetic sheet including magnetic particles and having a groove portion formed in one surface thereof, the groove portion having a shape corresponding to a coil pattern; and a coil disposed in the groove portion.

The magnetic sheet may have a thickness of 0.1 mm to 0.5 mm.

The magnetic sheet may have a thickness of 0.25 mm to 0.5 mm.

The coil pattern may be in a form of a spiral having two or more turns.

The magnetic particles may include at least one of a metal powder, metal flakes, and ferrite.

The metal power and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

The ferrite may include nickel-zinc-copper (Ni—Zn—Cu) or manganese-zinc (Mn—Zn).

According to another aspect of the present invention, there is provided a method of manufacturing an electromagnetic induction module for a wireless charging element, the method including: preparing a green sheet using a paste including magnetic particles; forming a groove portion having a shape corresponding to a coil pattern in the green sheet; forming a magnetic sheet by sintering the green sheet; and forming a coil in the groove portion through a plating process.

The magnetic sheet may have a thickness of 0.1 mm to 0.5 mm.

The magnetic sheet may have a thickness of 0.25 mm to 0.5 mm.

The coil pattern may be in a form of a spiral having two or more turns.

The magnetic particles may include at least one of a metal powder, metal flakes, and ferrite.

The metal power and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

The ferrite may include nickel-zinc-copper (Ni—Zn—Cu) or manganese-zinc (Mn—Zn).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an electromagnetic induction module for a wireless charging element according to an embodiment of the present invention;

FIG. 2 is a cross-sectional view taken along line A-A′ of FIG. 1;

FIG. 3 is a process view illustrating a method of manufacturing an electromagnetic induction module for a wireless charging element according to an embodiment of the present invention;

FIG. 4 is a graph illustrating wireless charging efficiency in accordance with a thickness of the electromagnetic induction module for a wireless charging element according to Inventive Example of the present invention and wireless charging efficiency in accordance with a thickness of an electromagnetic induction module for a wireless charging element according to Comparative Example; and

FIG. 5 is a cross-sectional view schematically showing a wireless charging element according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Meanwhile, in describing the embodiment of the present invention, a wireless charging element may be comprehensively referred to as a wireless power transmitting device that transmits power and a wireless power receiving device that receives and stores power.

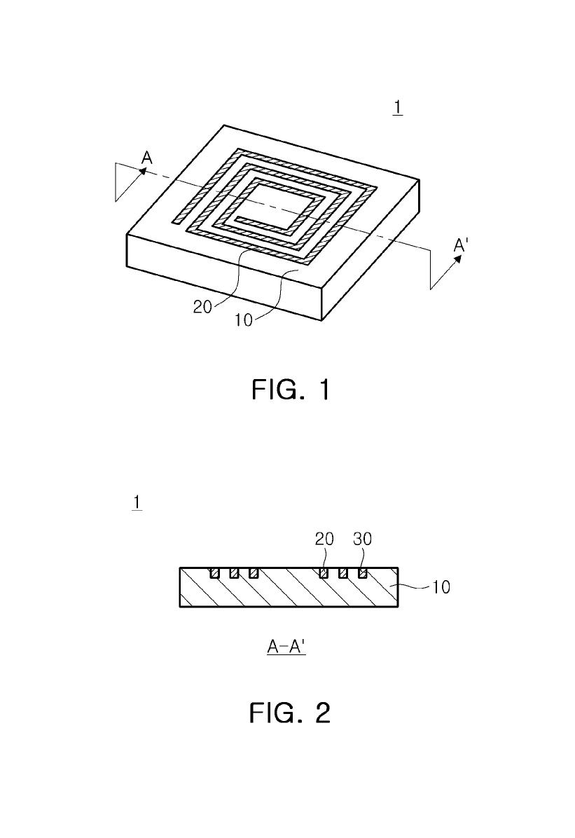

FIG. 1 is a perspective view showing an electromagnetic induction module 1 for a wireless charging element according to an embodiment of the present invention.

FIG. 2 is a cross-sectional view taken along line A-A′ of FIG. 1.

Referring to FIGS. 1 and 2, the embodiment of the present invention provides the electromagnetic induction module 1 for a wireless charging element including a magnetic sheet 10 including a groove portion 30, and a coil 20 disposed in the groove portion 30.

The magnetic sheet 10 may include magnetic particles and the magnetic particles may include at least one of a metal powder, metal flakes, and ferrite.

The metal powder and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy, but are not limited thereto.

The ferrite may include at least one of nickel-zinc-copper (Ni—Zn—Cu) and manganese-zinc (Mn—Zn), but is not limited thereto.

The groove portion 30, a space having the coil 20 disposed therein, may have a shape corresponding to a pattern shape of the coil 20.

Unlike a method of bonding the magnetic sheet and the coil that are separated from each other by an adhesive layer according to the related art, the coil 20 may be directly formed on the magnetic sheet 10 to reduce the thickness of the wireless charging element.

Further, according to the embodiment, the groove portion 30 is formed in the magnetic sheet 10 and the coil 20 is disposed in the groove portion 30, whereby wireless charging efficiency may be improved, as compared with the case using a method of disposing the coil 20 without forming the groove portion 30 in the magnetic sheet 10.

The reason for this is that in an overall thickness of the module, a thickness ratio of the magnetic sheet 10 is increased in the case that the groove portion 30 is formed in the magnetic sheet 10 and the coil 20 is disposed in the groove portion 30, as compared to the case in which the groove portion 30 is not formed in the magnetic sheet 10 and the coil 20 is formed on the magnetic sheet 10, when the electromagnetic induction module 1 is manufactured to have the same thickness in both cases.

According to the embodiment of the present invention, the electromagnetic induction module 1 for a wireless charging element may have a thickness of 0.1 mm to 0.5 mm.

FIG. 4 is a graph illustrating wireless charging efficiency in accordance with a thickness of the electromagnetic induction module for a wireless charging element according to Inventive Example of the present invention and wireless charging efficiency in accordance with a thickness of an electromagnetic induction module for a wireless charging element according to Comparative Example.

When the thickness of the electromagnetic induction module 1 is 0.5 mm or less, the electromagnetic induction module may have commerciality as a configuration of the wireless charging element, while when the thickness thereof exceeds 0.5 mm, a difference in terms of charging efficiency is rarely present in the electromagnetic induction module as compared with the case in which the groove portion is not formed and the coil is independently formed on the magnetic sheet (Comparative Example of FIG. 4). Further, when the thickness of the electromagnetic induction module 1 is less than 0.1 mm, a magnetic field absorption effect is lowered and accordingly, the charging efficiency is below 50%, such that the electromagnetic induction module 1 does not function appropriately as a wireless charging component and has little difference in terms of charging efficiency as compared with the case in which the magnetic sheet and the coil are formed separately (Comparative Example of FIG. 4).

Further, as illustrated in FIG. 4, it can be appreciated that an increasing rate of charging efficiency is reduced at a point at which the thickness of the electromagnetic induction module 1 is 0.25 mm, as a boundary. That is, when the thickness of the electromagnetic induction module 1 is less than 0.25 mm, a thickness ratio of the magnetic sheet to the coil in the electromagnetic induction module is rapidly increased and therefore, charging efficiency is sharply increased, and the thickness ratio of the magnetic sheet to the coil is maintained to have a predetermined level when the thickness of the electromagnetic induction module 1 is 0.25 mm or greater, such that the charging efficiency is smoothly increased even when the thickness of the electromagnetic induction module is increased.

Therefore, the thickness of the electromagnetic induction module 1 may be in a range of 0.25 mm and 0.5 mm, in which the effect of forming the groove portion in the magnetic sheet and disposing the coil in the groove portion according to the embodiment of the present invention is most significantly shown.

Since the coil 20 is formed in the groove portion 30 of the magnetic sheet 10 provided as a green sheet, a further increase in thickness due to the coil 20 may not be generated. Therefore, the thickness of the electromagnetic induction module 1 according to the embodiment of the present invention may be equal to a thickness of the magnetic sheet 10, and the thickness of the magnetic sheet 10 may be 0.5 mm or less.

The pattern shape of the coil 20 is not limited thereto, but may be in a form of a spiral having two or more turns . The form of a spiral may be a circular shape, a quadrangular shape, or the like, and the pattern shape of the coil 20 for wireless charging may be varied to have other shapes.

The coil 20 has a magnetic circuit formed therein to transmit a magnetic field induced by an input current or receive the induced magnetic field to generate an induced current, thereby enabling wireless (contactless) power transmission.

Generally, when the electromagnetic induction module 1 is used in a wireless charging element, the electromagnetic induction module 1 needs to be repeatedly bonded to or separated from a flat surface, a curved surface, or an uneven surface. Therefore, the magnetic sheet 10 may have flexibility through half-cutting the magnetic sheet 10.

In a half-cutting process, a groove is formed in a green sheet so as to have a depth equal to half or less of a sheet thickness, and the groove may be formed in a flat surface in a matrix pattern form. However, the groove may be varied in other pattern forms, without being limited thereto.

The groove may be a U-shaped groove or a V-shaped groove, and the shape of the groove may be appropriately selected according to the intended purpose thereof.

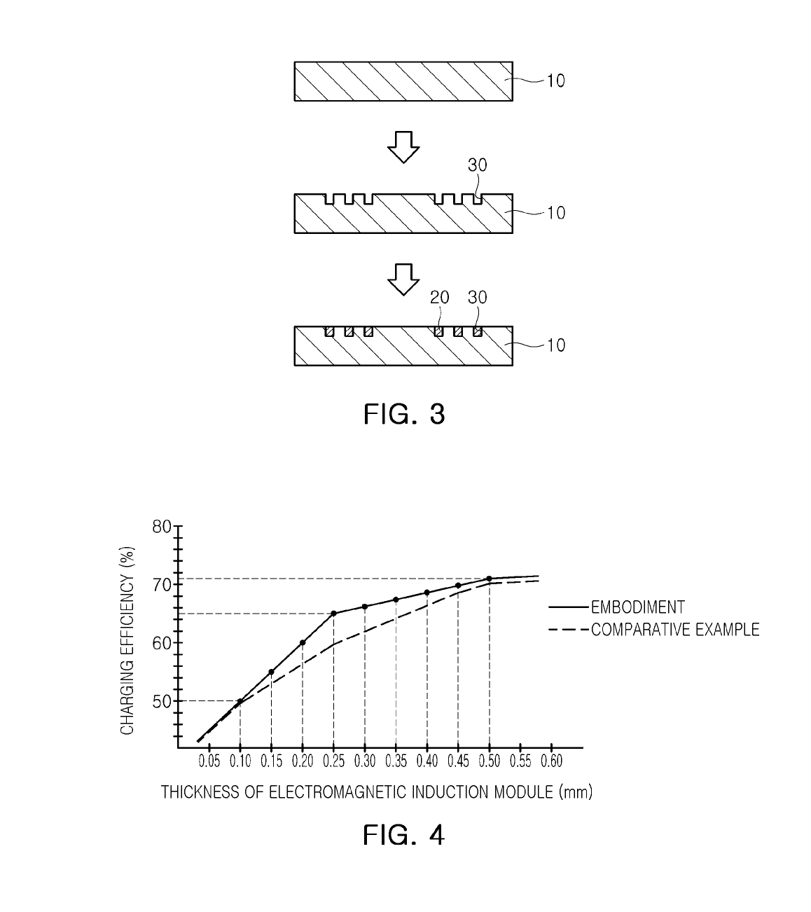

FIG. 3 is a process view illustrating a method of manufacturing the electromagnetic induction module 1 for a wireless charging element according to an embodiment of the present invention.

Referring to FIG. 3, the method of manufacturing the electromagnetic induction module 1 for a wireless charging element according to an embodiment of the present invention includes; preparing a green sheet using a paste including magnetic particles; forming a groove portion 30 having a shape corresponding to the pattern shape of the coil 20 in the green sheet; forming the magnetic sheet 10 by sintering the green sheet; and forming the coil 20 in the groove portion 30 through a plating process.

Meanwhile, the green sheet may be manufactured in a sheet form using a tape casting process, a doctor blade method, or the like by mixing the magnetic particles having compositions for achieving desired characteristics with a binder and a molding solvent. However, the method of manufacturing a green sheet is not limited thereto, and therefore any method able to handle sintering of magnetic particles maybe used without being limited.

The paste used for forming a green sheet may be prepared by mixing magnetic particles having an appropriate composition and including at least one of a metal powder, metal flakes and ferrite with a binder resin and adding a volatile solvent thereto so as to control viscosity.

The volatile solvent is not limited thereto, but may include at least one of toluene, alcohol, and methyl ethyl ketone (MEK).

The binder may be at least one selected from a group consisting of water glass, polyimide, polyamide, silicon, phenol resin, and an acrylic, but is not limited thereto.

A ceramic powder may be added to the paste if the paste needs to have insulating properties, and the ceramic powder may include kaolin, talc, and the like, but any material having electrical insulating properties may be used without being limited thereto.

The green sheet may be formed by applying the paste to have a thickness of 0.1 mm to 0.5 mm and performing drying thereon.

The groove portion 30 may be formed in the green sheet in order to dispose the coil 20 therein by a method such as laser etching, and the like, and the magnetic sheet 10 may be formed by sintering the green sheet.

The coil 20 may be disposed in the groove portion 30 through the plating process.

In order to avoid overlapped descriptions, descriptions of elements overlapped with the above-described electromagnetic induction module 1 for the wireless charging element according to the embodiment of the present invention will be omitted, in a description of the method of manufacturing of the electromagnetic induction module for the wireless charging element.

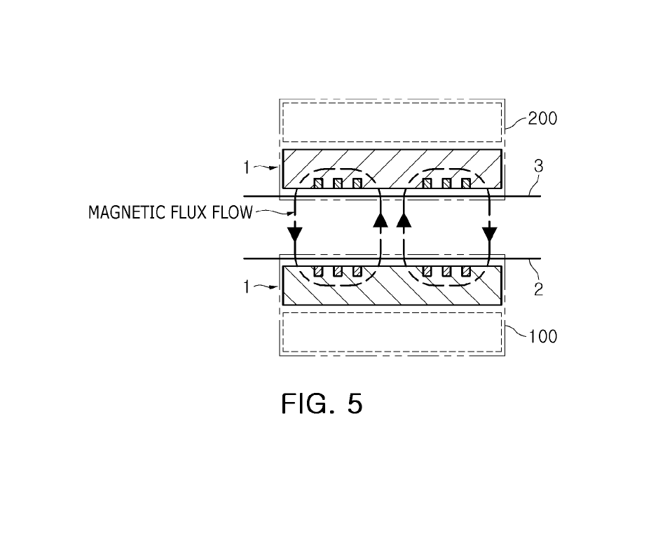

FIG. 5 is a cross-sectional view schematically showing a wireless charging element according to another embodiment of the present invention.

Referring to FIG. 5, the wireless charging element includes a wireless charging transmitter 100 and a wireless charging receiver 200. Each of the wireless charging receiver 100 and the wireless charging receiver 200 may include the electromagnetic induction module 1 for a wireless charging element including the magnetic sheet 10 including magnetic particles and having the groove portion 30 formed in one surface thereof, the groove portion 30 having a shape corresponding to the pattern shape of the coil 20; and the coil 20 disposed in the groove portion 30.

When AC voltage is applied to the coil 20 of the wireless charging transmitter 100, a magnetic field around the coil 20 is changed and a magnetic field around the coil 20 of the wireless charging receiver 200 adjacently disposed to the wireless charging transmitter 100 is changed accordingly.

The coil 20 of the wireless charging receiver 200 may transmit voltage according to the change in magnetic field in the coil 20 of the wireless charging receiver 200.

As set forth above, according to the embodiments of the present invention, the electromagnetic induction module for a wireless charging element allowing for a reduction in a thickness of a wireless charging element and improving charging efficiency, and the method of manufacturing the same can be provided.

While the present invention has been shown and described in connection with the embodiments, it will be apparent to those skilled in the art that modifications and variations can be made without departing from the spirit and scope of the invention as defined by the appended claims.

1. An electromagnetic induction module for a wireless charging element, comprising:
a magnetic sheet including magnetic particles and having a groove portion formed in one surface thereof, the groove portion having a shape corresponding to a coil pattern; and
a coil disposed in the groove portion,
wherein the magnetic sheet has a thickness of 0.25 mm to 0.5 mm.

2-3. (canceled)

4. The electromagnetic induction module of claim 1, wherein the coil pattern is in a form of a spiral having two or more turns.

5. The electromagnetic induction module of claim 1, wherein the magnetic particles include at least one of a metal powder, metal flakes, and ferrite.

6. The electromagnetic induction module of claim 5, wherein the metal power and the metal flakes include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

7. The electromagnetic induction module of claim 5, wherein the ferrite includes nickel-zinc-copper (Ni—Zn—Cu) or manganese-zinc (Mn—Zn).

8. A method of manufacturing an electromagnetic induction module for a wireless charging element, the method comprising:
preparing a green sheet using a paste including magnetic particles;
forming a groove portion having a shape corresponding to a coil pattern in the green sheet;
forming a magnetic sheet by sintering the green sheet; and
forming a coil in the groove portion through a plating process.

9. The method of claim 8, wherein the magnetic sheet has a thickness of 0.1 mm to 0.5 mm.

10. The method of claim 8, wherein the magnetic sheet has a thickness of 0.25 mm to 0.5 mm.

11. The method of claim 8, wherein the coil pattern is in a form of a spiral having two or more turns.

12. The method of claim 8, wherein the magnetic particles include at least one of a metal powder, metal flakes, and ferrite.

13. The method of claim 12, wherein the metal power and the metal flakes include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

14. The method of claim 12, wherein the ferrite includes nickel-zinc-copper (Ni—Zn—Cu) or manganese-zinc (Mn—Zn).

15. The electromagnetic induction module of claim 1, wherein the magnetic particles are distributed throughout a substantial portion of the magnetic sheet, and wherein the coil further includes an electrically conductive material separate from the magnetic particles.

16. The electromagnetic induction module of claim 15, wherein the coil and the magnetic sheet are separated from each other by at least one additional layer.
